(19) United States
(12) Patent Application Publication
(10) Pub. No.: US 2012/0188124 A1
(43) Pub. Date: Jul. 26, 2012

(54) GNSS RECEIVER AND OPERATING METHOD

(76) Inventors: Martin Borjesson Reidevall, Hagersten (SE); Mats Robin Hakanson, Cedar Rapids, IA (US); Alexander Michael Mitelman, Stockholm (SE)

(21) Appl. No.: 13/322,865

(22) PCT Filed: Jun. 29, 2009
(86) PCT No.: PCT/EP2009/058082

§ 371 Date: Apr. 13, 2012

(51) Int. Cl. G01S 19/28

(52) U.S. Cl. 342/357.67

(57) ABSTRACT

A GNSS receiver (100) receives radio signals (S(SV)) transmitted from an active set of signal sources (SV1, SV2, SV3, SV5) and based thereon produces position/time related data (D_{PT}). The receiver (100) has a tracking channel resource for each signal source (SV1, SV2, SV3, SV5) in the active set, and the tracking channel resources process the radio signals (S(SV)) in parallel with respect to a real-time signal data rate of the signals. The receiver (100) also includes a signal-source database (140), a signal-masking database (150) and a control unit (130). The signal-source database (140) describes the movements of the signal sources (SV1, SV2, SV3, SV4, SV5) over time relative to a given reference frame, and the signal-masking database (150) reflects, for positions (P) within a predefined geographic area, visibility/blockage to the sky with respect to a direct line of sight in terms of spatial sectors (M₁(P), M₂(P) M₃(P)). The control unit (130) derives data describing a current position/time (PT_{R}(t)) and a current velocity vector (V_{R}(t)) for the receiver (100) based on the position/time related data (D_{PT}); and derives an estimated visibility of the signal sources (SV1, SV2, SV3, SV5) in the active set at a second position/time (PT_{R}(t+Δt)) representing an expected future position/time for the receiver (100) based on the signal-source and signal-masking databases (140; 150). If at least one signal source (SV1) in the active set is estimated not to be visible at the second position/time (PT_{R}(t+Δt)), the control unit (130) initiates a modification of the active set aiming at replacing the at least one non-visible signal source (SV1) with at least one signal source (SV4) which, based on the signal-source and signal-masking databases (140; 150), is estimated to be visible at the second position/time (PT_{R}(t+Δt)).

### THE BACKGROUND OF THE INVENTION AND PRIOR ART

The present invention relates generally to reception and processing of spread spectrum signals in Global Navigation Satellite System (GNSS) receivers. More particularly the invention relates to a receiver according to the preamble of claim 1 and a method of operating a receiver according to the preamble of claim 10. The invention also relates to a computer program according to claim 17 and a computer readable medium according to claim 18.

Many examples of GNSSs exist. Presently, the Global Positioning System (GPS; U.S. Government) is the dominant system; however alternative systems are expected to gain increased importance in the future. So far, the GLObal NAvigation Satellite System (GLONASS; Russian Federation Ministry of Defense) and the Galileo system (the European programme for global navigation services) constitute the major alternative GNSSs. Various systems also exist for enhancing the coverage, the availability and/or the quality of at least one GNSS in a specific region. The Quasi-Zenith Satellite System (QZSS; Advanced Space Business Corporation in Japan), the Wide Area Augmentation System (WAAS; The U.S. Federal Aviation Administration and the Department of Transportation) and the European Geostationary Navigation Overlay Service (EGNOS; a joint project of the European Space Agency, the European Commission and Euro-control—the European Organisation for the Safety of Air Navigation) represent examples of such augmentation systems for GPS, and in the latter case GPS and GLONASS.

The hardware constraints of the first generation of GPS receivers were such that these devices processed satellite signals by means of a single channel. In the early designs, the receiver operated sequentially to determine a geographical coordinate based on several satellite signals. M. Weiss describes one example of such a receiver design in PLANS '82—Position Location and Navigation Symposium, Atlantic City, N.J., Dec. 6-9, 1982, Record (A84-12426 02-04). New York, Institute of Electrical and Electronics Engineers, 1982, p. 275-278.

By comparison, modern GPS receivers typically employ parallel tracking. This means that the receiver has dedicated hardware to receive multiple signals simultaneously. Normally, this decreases the expected time to identify and acquire the signals from a sufficient number of satellites compared to a single-channel receiver. The parallel receiver also has improved reliability and accuracy.

Furthermore, there exist various forms of hybrid receivers employing both parallel and serial processing of satellite signals.

Whatever the type of receiver, GNSS navigation can be highly challenging in some radio environments, particularly when the characteristics of these environments are rapidly varying. By design, the signal sources (i.e. the satellites) move across the sky with varying trajectories depending on the receiver's position relative to the signal sources in question. Moreover, the receiver often moves, and as a result the radio conditions may be drastically altered. Occasionally, the signals from one or more signal sources may be completely blocked with no prior warning or indication thereof, for example if the receiver passes a corner of a high building. Due to the varying radio conditions, the set of radio signals based upon which the receiver produces position/time related data must be refreshed repeatedly. However, effecting this updating is not a trivial task, especially not if the available time is short relative to the required update frequency of the position/time related data. Namely, in order to include any recently unobscured signals in the navigation solution, a so-called rapid acquisition process with respect to these signals must be completed to determine the data necessary to track them continuously. Failure to re-acquire the tracking data quickly enough may force the receiver to perform conventional re-acquisition or even full power acquisition, which consumes significant power and can cause degradation, or a complete outage, in the production of the position/time related data.

### SUMMARY OF THE INVENTION

The object of the present invention is to alleviate the above problems and provide an efficient and robust solution capable of producing position/time related data based on received signals even when the radio conditions change rapidly.

According to the invention, the object is achieved by the GNSS receiver as initially described, wherein the receiver includes a signal-masking database and a control unit. The signal-masking database reflects visibility/blockage to the sky with respect to a direct line of sight in terms of spatial sectors for positions in a predefined geographic area. The control unit is configured to derive data describing a current position/time and a current velocity vector for the receiver based on the position/time related data. On the basis of the signal-source and signal-masking databases, the control unit is also configured to derive an estimated visibility of the signal sources in the active set at a second position/time representing an expected future position/time for the receiver. If at least one signal source in the active set is estimated not to be visible at the second position/time, the control unit is configured to initiate a modification of the active set aiming at replacing the at least one non-visible signal source with at least one signal source which, based on the signal-source and signal-masking databases, is estimated to be visible at the second position/time.

This receiver design is advantageous because it significantly increases the receiver's chances of avoiding positioning discontinuities, or outages, due to signal blockage, especially in difficult environments, such as urban areas.

According to one preferred embodiment of the invention, the control unit is configured to initiate the modification of the active set before the receiver reaches the second position/time. Hence, the risk of signal outage is further reduced.

According to another preferred embodiment of the invention, the control unit is configured to repeatedly update the signal-source database based on received orbital data describing the movements of the signal sources. Thereby, continued high performance of the receiver can be guaranteed.

According to still another preferred embodiment of the invention, the orbital data comprises ephemeris data and/or almanac data. This is information that normally is stored in the receiver, and therefore no additional storage space is required for this aspect of the proposed solution.

According to a further preferred embodiment of the invention, the control unit is configured to implement a ray-tracing algorithm in conjunction with information from the signal-source and signal-masking databases to estimate whether or not a signal source is visible at a given position/time. This is useful because the ray-tracing algorithm is a highly efficient tool for determining if an unobstructed line of sight exists between two points in space. Moreover, highly optimized implementations of these algorithms exist.

According to another preferred embodiment of the invention, the signal processing unit is configured to implement the control unit. For example, the two units may be implemented in a common processing unit where the control unit forms a part of the signal processing unit. This is beneficial with respect to efficiency as well as speed. Further preferably, the signal processing unit is at least partly implemented in software running on the processor.

According to still another preferred embodiment of the invention, the receiver includes a calculator module configured to derive a first part of the signal-masking database based on an altimetric database describing in three dimensions the respective positions and extensions of stationary objects on Earth, which objects may potentially intersect a signal transmission path between a signal source in the GNSS and the receiver. Hence, information concerning manmade objects (e.g. buildings, bridges) and natural objects (e.g. terrain) can be used to determine the estimated visibility of the signal sources.

According to yet another preferred embodiment of the invention, the calculator module is configured to derive at least one second part of the signal-masking database based on measurements in respect of signal sources in the GNSS from which signals have been received in at least one geographic position. Thus, the receiver may gradually improve its knowledge about factors influencing the radio environment in which it roams, and consequently its performance can be enhanced.

According to another aspect of the invention, the object is achieved by the method described initially, wherein data are derived that describe a current position/time and a current velocity vector for the receiver based on the position/time related data. Further, an estimated visibility of the signal sources in the active set at a second position/time is derived. The second position/time represents an expected future position/time for the receiver, and the estimated visibility is derived by consulting a signal-source database and a signal-masking database reflecting, for positions within in a predefined geographic area, visibility/blockage to the sky with respect to a direct line of sight in terms of spatial sectors. If at least one signal source in the active set is estimated not to be visible at the second position/time, a modification of the active set is initiated aiming at replacing the at least one signal source that is expected not to be visible at the second position/time with at least one signal source which, based on the signal-source and signal-masking databases, is estimated to be visible at the future position/time. The advantages of this method, as well as the preferred embodiments thereof, are apparent from the discussion above with reference to the proposed receiver.

According to a further aspect of the invention the object is achieved by a computer program, which is directly loadable into the memory of a computer, and includes software adapted to implement the method proposed above when said program is run on a computer.

According to another aspect of the invention the object is achieved by a computer readable medium, having a program recorded thereon, where the program is to control a computer to perform the method proposed above when the program is loaded into the computer.

Further advantages, beneficial features and applications of the present invention will be apparent from the following description and the dependent claims.

### BRIEF DESCRIPTION OF THE DRAWINGS

The present invention is now to be explained more closely by means of preferred embodiments, which are disclosed as examples, and with reference to the attached drawings.

FIG. 1 shows a block diagram of a GNSS receiver according to one embodiment of the invention;

FIG. 2 shows a group of signal sources and a proposed receiver when located at a first and a second position respectively;

FIG. 3 illustrates a proposed signal-masking database, which reflects visibility/blockage to the sky with respect to a direct line of sight in terms of spatial sectors for positions within a predefined geographic area; and

FIG. 4 illustrates, by means of a flow diagram, a general method of operating a GNSS receiver according to one preferred embodiment of the invention.

### DESCRIPTION OF PREFERRED EMBODIMENTS OF THE INVENTION

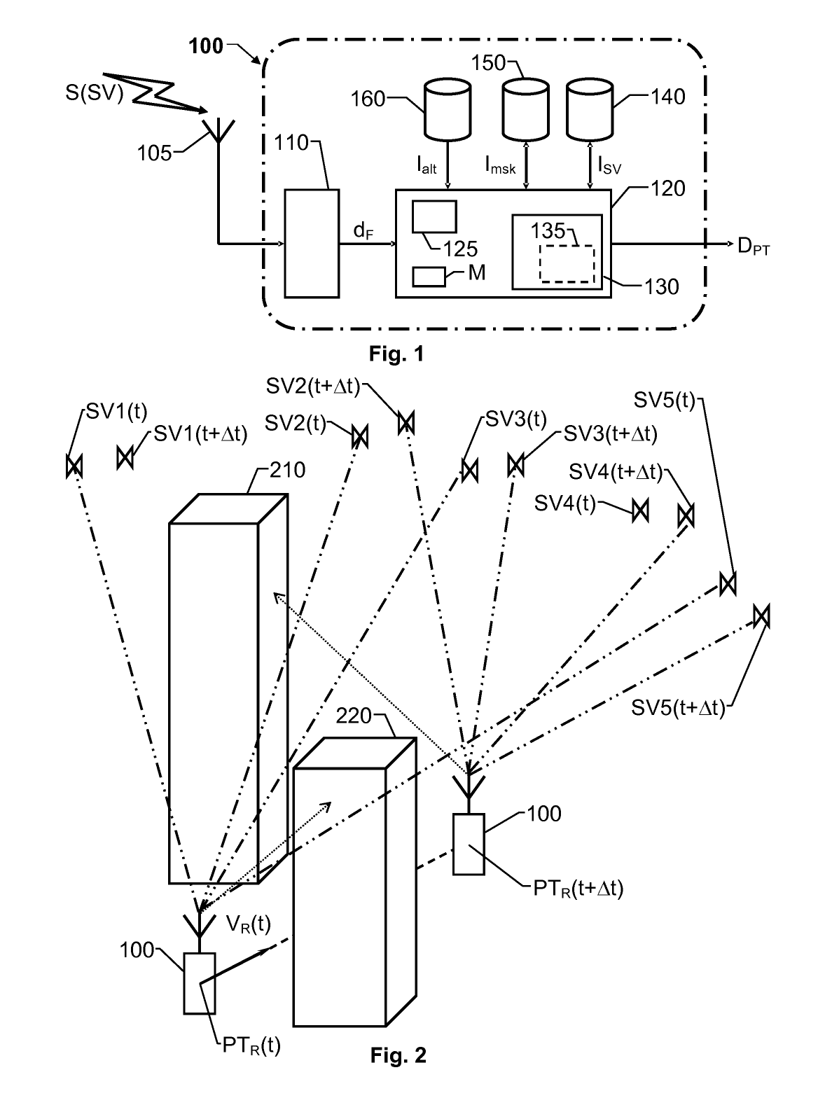

We refer initially to FIGS. 1 and 2, which show a block diagram of a GNSS receiver 100 according to one embodiment of the invention respective a group of signal sources and the receiver at two different positions/times.

The proposed receiver 100 is adapted to process radio signals S(SV) transmitted from an active set of signal sources and based thereon produce position/time related data D_{PT}. Here, we assume that at a first position/time PT_{R}(t), the active set includes a first signal source SV1, a second signal source SV2, a third signal source SV3 and a fifth signal source SV5. The receiver 100 has a tracking channel resource for each signal source in the active set, and the tracking channel resources are configured to process the radio signals S(SV) in parallel with respect to a real-time signal data rate of the signals.

The proposed receiver 100 includes a signal-source database 140, a signal-masking database 150 and a control unit 130. The signal-source database 140 describes the movements of the signal sources SV1, SV2, SV3, SV4 and SV5 over time relative to a given reference frame, e.g. the Earth. Of course, in practice, the signal-source database 140 also describes the movements of a number of additional signal sources in relevant GNSS(s). Hence, the signal-source database 140 may contain orbital data in the form of ephemeris data and/or almanac data. The almanac is a data collection that describes the signal sources’ movements over time. The almanac is typically associated with Time of Applicability (TOA) data indicating a validity time. The ephemeris data constitutes an increased accuracy version of the almanac data, and is usually received via broadcasting and/or assistance (e.g. Assisted GPS (AGPS)). Normally, the ephemeris data is associated with an issue of data, ephemeris (IODE) parameter, which indicates how old the information is. Hence, the receiver 100 has access to pertinent information regarding the positions of the signal sources. According to one preferred embodiment of the invention, the control unit 130 is configured to repeatedly update the signal-source database 140 based on such received orbital data (i.e. describing the movements of the signal sources SV1, SV2, SV3, SV4 and SV5).

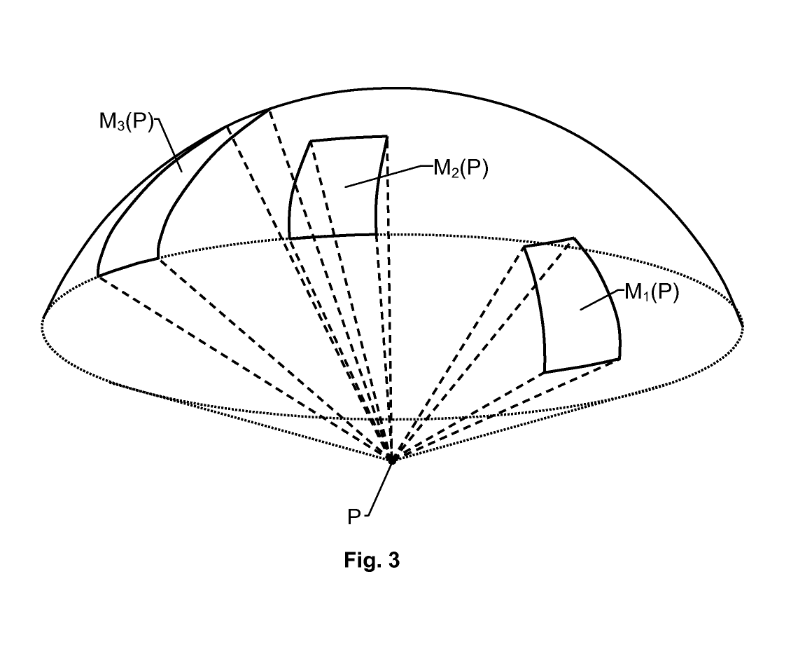

FIG. 2 illustrates the positions of signal sources SV1, SV2, SV3, SV4 and SV5 at a first position/time t and at a second position/time t+Δt respectively. Referring now to FIG. 3, the signal-masking database 150 reflects, for positions P within a predefined geographic area, visibility/blockage to the sky with respect to a direct line of sight in terms of spatial sectors. For example, any signal from spatial sectors M₁(P), M₂(P) and M₃(P) of the sky is blocked from reaching the position P via a direct line of sight. The signal-masking database 150 may either describe the spatial sectors M₁(P), M₂(P) and M₃(P) directly/explicitly in terms of sections of the sky being obstructed at each position P, or it may contain data based on which said visibility/blockage is derivable at various positions P. In the latter case, the signal-masking database 150 may describe primary information like the coordinates for and the geometric extensions of various structures, e.g. buildings, bridges, mountains and terrain, preferably a compact representation, such as in vectorized form. Given said primary information, the control unit 130 may then derive secondary information regarding the spatial sectors M₁(P), M₂(P) and M₃(P) on the fly, i.e. whenever such information is needed in the receiver 100.

In any case, the control unit 130 is configured to derive data describing a current position/time PT_{R}(t) and a current velocity vector V_{R}(t) for the receiver 100 based on the position/time related data D_{PT}. Moreover, based on the signal-source and signal-masking databases 140 and 150, the control unit 130 is configured to determine an estimated visibility of the signal sources SV1, SV2, SV3 and SV5 in the active set at a second position/time PT_{R}(t+Δt). The second position/time PT_{R}(t+Δt) here represents an expected future position/time for the receiver 100 given the current velocity vector v_{R}(t).

If at least one signal source SV1 in the active set is estimated not to be visible at the second position/time PT_{R}(t+Δt), the control unit 130 is configured to initiate a modification of the active set aiming at replacing the at least one non-visible signal source SV1 with at least one signal source SV4 which, based on the signal-source and signal-masking databases 140 and 150, is estimated to be visible at the second position/time PT_{R}(t+Δt). According to one preferred embodiment of the invention, the control unit 130 is configured to initiate the modification of the active set before the receiver 100 reaches the second position/time PT_{R}(t+Δt). This is advantageous because by beginning to modify the active set sufficiently in advance the risk of signal outage can be reduced significantly, and thus the continuity and/or the quality of the navigation can be increased. The velocity vector v_{R}(t) is an important factor for determining when it is appropriate to start the active set modification. Generally, a high velocity requires a relatively early start, whereas the modification can be started relatively late if the velocity is low.

According to one preferred embodiment of the invention, the control unit 130 is configured to implement a ray-tracing algorithm in conjunction with information Iₘₛₖ and I_{SV} from the signal-source and signal-masking databases 140 and 150 respectively to estimate whether or not a signal source SV1, SV2, SV3, SV4 or SV5 is visible at a given position/time PT_{R}(t) and PT_{R}(t+Δt). Traditionally, ray-tracing algorithms have been used in computer graphics to render two-dimensional projections of three-dimensional scenes for example in simulations, Computer Aided Design (CAD) and computer games. A ray tracing algorithm represents a technique for generating an image by tracing the path of light through pixels in an image plane. The technique is capable of producing a very high degree of photorealism. Ray tracing is capable of simulating a wide variety of optical effects, such as reflection and refraction, scattering, and chromatic aberration. Over the years these algorithms have become very efficient, and today high-quality image results can be produced in real time.

Since high-frequency radio waves and visible light both propagate along a line of sight, the present invention may reuse the capability of the ray tracing algorithms to describe various light sources' illumination of areas and surfaces by regarding the signal sources SV1, SV2, SV3, SV4, and SV5 as “light sources”, and investigating whether or not the signal from a given source reaches the receiver 100 via a direct line of sight when being located at a given position.

According to one preferred embodiment of the invention, the receiver 100 includes a calculator module 125, which is configured to derive a first part of the signal-masking database 150 based on an altimetric database 160. The altimetric database 160 describes in three dimensions Iₐₗₜ respective positions and extensions of stationary objects, e.g. buildings 210 and 220, which may potentially intersect a signal transmission path between a signal source SV1, SV2, SV3, SV4 and/or SV5 in the GNSS and the receiver 100. Thus, the altimetric database 160 is a form of 3D map over a certain area, which map is loaded into the receiver 100. Moreover, the calculator module 125 is preferably configured to derive at least one second part of the signal-masking database 150 based on measurements in respect of the signal sources SV1, SV2, SV3, SV4 and/or SV5 in the GNSS from which signals S(SV) have been received in at least one geographic position P. Thereby, based on actual measurements, the receiver 100 may update the signal-masking database 150, such that it describes the radio environment more and more accurately. Thus, the receiver 100 may operate in with gradually improving quality.

In addition to the above-mentioned units, the receiver 100 preferably further includes a radio front-end unit 110 and a radio signal processing unit 120. The processing unit 120 is here configured to implement the tracking channel resources for the signal sources in the active set. The radio front-end unit 110 is configured to receive the radio signals S(SV) via an antenna means 105 from a plurality of signal sources, typically a set of satellites belonging to one or more GNSSs. To this aim the antenna means 105 is designed to receive radio frequency signals in at least one frequency band, e.g. the L1-, L2- and/or L5/E5a-bands, i.e. having spectra ranging from 1563 MHz to 1587 MHz, 1215 MHz to 1240 MHz and 1155 MHz to 1197 MHz respectively. Furthermore, the radio front-end unit 110 is adapted to perform downconversion, sampling and digitizing of the received radio signals S(SV), and to produce a resulting digital representation d_{F} having a data format adapted for processing in the processing unit 120. Thus, based on said digital representation d_{F}, the radio signal processing unit 120 can perform relevant further signal processing to generate position/time related data D_{PT}. For example, the radio front-end unit 110 may directly sample a bandpass version of the radio signals S(SV), or the unit 110 may execute I/Q, or IF, bandpass sampling, and thus frequency downconvert the received signals S(SV) to the baseband.

The receiver 100 preferably also includes, or is associated with, a computer readable medium M, such as a memory buffer, storing a program which is adapted to control the receiver 100 to operate according to the proposed principle.

It is generally preferable if the control unit 130 is at least partly implemented in software 135 running on the radio signal processor 120. In fact, the control unit 130 may be entirely implemented in software. However it is also feasible that one or more separate units, e.g. realized in a Field Programmable Gate Array (FPGA) design or an application-specific integrated circuit (ASIC), are adapted to perform at least one of the control unit's 130 processing functions.

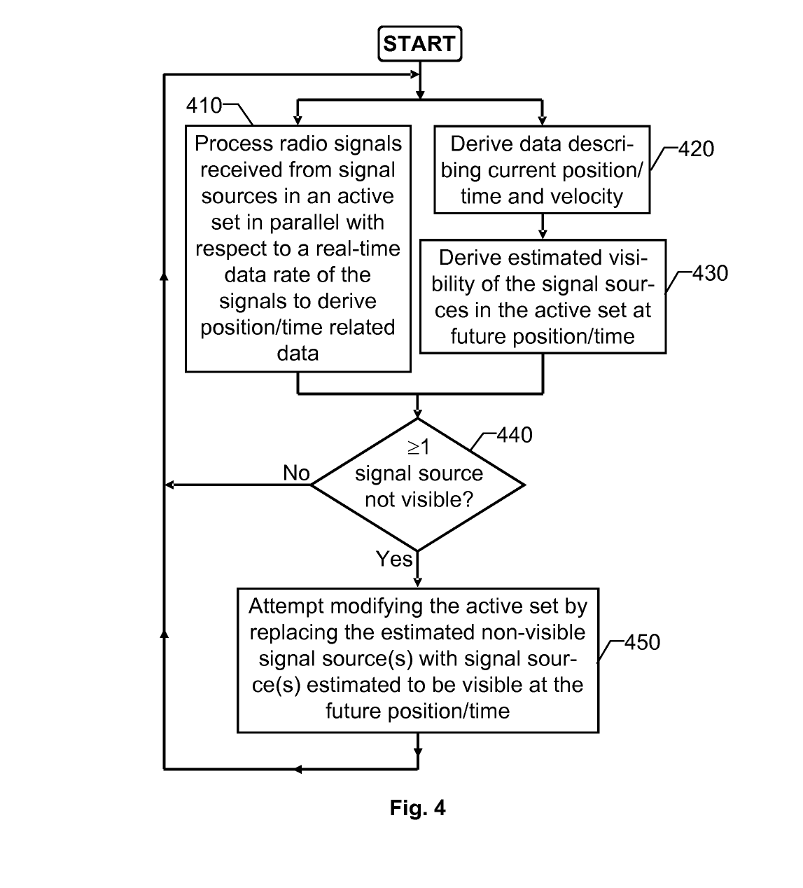

To sum up, we will now describe the method of controlling a GNSS receiver according to a preferred embodiment of the invention with reference to the flow diagram in FIG. 4. It is here presumed that radio signals are transmitted from a number of signal sources in at least one GNSS, that the receiver is configured to receive these signals, and based thereon produce position/time related data. Specifically, the receiver has a tracking channel resource for each signal source in an active set, and the tracking channel resources are configured to process the radio signals in parallel with respect to a real-time signal data rate of the signals.

An initial step 410 processes radio signals from signal sources in an active set in parallel with one another regarding a real-time signal data rate of the signals, and derives position/time related data. A parallel step 420, derives data describing a current position/time and a current velocity vector for the receiver. Thereafter, a step 430 derives an estimated visibility of the signal sources in the active set at a second position/time. The second position/time represents an expected future position/time for the receiver that is given by said velocity vector. The estimated visibility is derived by consulting a signal-source database and a signal-masking database reflecting, for positions within a predefined geographic area, visibility/blockage to the sky with respect to a direct line of sight in terms of spatial sectors.

After steps 410 and 430, a step 440 checks if at least one signal source in the active set is estimated not to be visible at the second position/time. If all signals sources of the present active set are estimated to be visible also at the second position/time, the procedure loops back to steps 410 and 420. Otherwise, i.e. if at least one signal source in the active set is estimated to be blocked at the second position/time, a step 450 follows.

Step 450 attempts to modify the active set by replacing the at least one signal source that is expected not to be visible at the second position/time with at least one signal source which, based on the signal-source and signal-masking databases, is estimated to be visible at the future position/time. In many cases the modification attempt proves successful. However, if for example the receiver travels into a tunnel or a building it may not be possible to find signal sources whose signals cover the future position/time. After step 450, the procedure loops back to steps 410 and 420, possibly with a modified active set.

All of the steps, as well as any sub-sequence of steps, described with reference to FIG. 4, above may be controlled by means of a programmed computer apparatus. Moreover, although the embodiments of the invention described above with reference to the drawings comprise computer apparatus and processes performed in computer apparatus, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the procedure according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc), an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant procedures.

The term “comprises/comprising” when used in this specification is taken to specify the presence of stated features, integers, steps or components. However, the term does not preclude the presence or addition of one or more additional features, integers, steps or components or groups thereof.

The reference to any prior art in this specification is not, and should not be taken as, an acknowledgement or any suggestion that the referenced prior art forms part of the common general knowledge in Australia.

The invention is not restricted to the described embodiments in the figures, but may be varied freely within the scope of the claims.

1. A GNSS receiver adapted to process radio signals transmitted from an active set of signal sources and based thereon produce position/time related data, the receiver comprising a tracking channel resource for each signal source in the active set, the tracking channel resources being configured to process the radio signals in parallel with respect to a real-time signal data rate of the signals, the receiver comprising a signal-source database describing the movements of the signal sources over time relative to a given reference frame, the active set of signal sources being a subset of the signal sources described in the signal-source database,
wherein the receiver further comprises:
a signal-masking database reflecting, for positions within a predefined geographic area, visibility/blockage to the sky with respect to a direct line of sight in terms of spatial sectors, and
a control unit configured to:
derive data describing a current position/time and a current velocity vector for the receiver based on the position/time related data,
derive an estimated visibility of the signal sources in the active set at a second position/time representing an expected future position/time for the receiver based on the signal-source and signal-masking databases, and if at least one signal source in the active set is estimated not to be visible at the second position/time
initiate a modification of the active set aiming at replacing the at least one non-visible signal source with at least one signal source which, based on the signal-source and signal-masking databases, is estimated to be visible at the second position/time.

2. The receiver according to claim 1, wherein the control unit is configured to initiate the modification of the active set before the receiver reaches the second position/time.

3. The receiver according to claim 1, wherein the control unit is configured to repeatedly update the signal-source database based on received orbital data describing the movements of the signal sources.

4. The receiver according to claim 3, wherein the orbital data comprises at least one of ephemeris data and almanac data.

5. The receiver according to claim 1, wherein the control unit is configured to implement a ray-tracing algorithm in conjunction with information from the signal-source and signal-masking databases to estimate whether or not a signal source is visible at a given position/time.

6. The receiver according to claim 1, comprising a signal processing unit is which configured to implement the control unit.

7. The receiver according to claim 1, comprising a signal processing unit which is at least partly implemented in software running on a processor.

8. The receiver according to claim 1, comprising a calculator module configured to derive a first part of the signal-masking database based on an altimetric database describing in three dimensions respective positions and extensions of stationary objects on Earth which objects may potentially intersect a signal transmission path between a signal source in the GNSS and the receiver.

9. The receiver according to claim 8, wherein the calculator module is configured to derive at least one second part of the signal-masking database based on measurements in respect of signal sources in the GNSS from which signals have been received in at least one geographic position.

10. A method of operating a GNSS receiver, the method comprising processing radio signals transmitted from an active set of signal sources and based thereon producing position/time related data, the receiver comprising a tracking channel resource for each signal source in the active set, and the tracking channel resources being configured to process the radio signals in parallel with respect to a real-time signal data rate of the signals, the method further comprising:
deriving data describing a current position/time and a current velocity vector for the receiver based on the position/time related data,
deriving an estimated visibility of the signal sources in the active set at a second position/time representing an expected future position/time for the receiver by consulting a signal-source database a signal-masking database reflecting, for positions within a predefined geographic area, visibility/blockage to the sky with respect to a direct line of sight in terms of spatial sectors, and if at least one signal source in the active set is estimated not to be visible at the second position/time
initiating a modification of the active set to replace the at least one signal source that is expected not to be visible at the second position/time with at least one signal source which, based on the signal-source and signal-masking databases, is estimated to be visible at the future position/time.

11. The method according to claim 10, comprising initiating the modification of the active set before the receiver reaches the second position/time.

12. The method according to claim 10, comprising updating repeatedly the signal-source database based on received orbital data describing the movements of the signal sources.

13. The method according to claim 12, wherein the orbital data comprises at least one of ephemeris data and almanac data.

14. The method according to claim 10, comprising estimating whether or not a signal source is visible at a given position/time based on a ray-tracing algorithm ray-tracing algorithm in conjunction with information from the signal-source and signal-masking databases.

15. The method according to claim 10, comprising deriving a first part of the signal-masking database based on a topographic database describing in three dimensions respective positions and extensions of stationary objects on Earth which objects may potentially intersect a signal transmission path between a signal source in the GNSS and the receiver.

16. The method according to claim 15, comprising deriving at least one second part of the signal-masking database based on measurements in respect of signal sources in the GNSS from which signals have been received in at least one geographic position.

17. A computer program loadable into the memory of a computer, comprising software for controlling the steps of the method of claim 10 when said program is run on the computer.

18. A computer readable medium, having a program recorded thereon, where the program is to make a computer control the steps of the method of claim 10 when the program is loaded into the computer.
